(19) United States
(12) Patent Application Publication
(10) Pub. No.: US 2025/0309656 A1
(43) Pub. Date: Oct. 2, 2025

(54) Orchestration of Distributed Behind-the-Meter Nanogrids

(71) Applicant: Pila Energy, Inc., San Francisco, CA (US)

(72) Inventors: Cole Ashman, San Francisco, CA (US); Eric Wang, Burlingame, CA (US); Nicholas Dunkel, San Francisco, CA (US)

(21) Appl. No.: 19/091,733

(22) Filed: Mar. 26, 2025

Related U.S. Application Data
(63) Continuation-in-part of application No. 19/083,668, filed on Mar. 19, 2025.
(60) Provisional application No. 63/569,986, filed on Mar. 26, 2024.
(60) Provisional application No. 63/680,432, filed on Aug. 7, 2024.
(60) Provisional application No. 63/683,114, filed on Aug. 14, 2024.
(60) Provisional application No. 63/689,550, filed on Aug. 30, 2024.

(51) Int. Cl. H02J 3/38; H02J 50/80

(52) U.S. Cl. CPC H02J 3/381; H02J 50/80; H02J 2300/24; H02J 2300/28

(57) ABSTRACT

A nanogrid system for managing power within a premises comprises a plurality of nanogrid nodes. Each nanogrid node includes a connection to a power source within the premises, a microgrid interconnection device (MID) configured to selectively disconnect from the power source, at least one power management component configured to provide backup power to one or more loads within a portion of the nanogrid system, and a peer-to-peer wireless connection with at least another nanogrid node of the plurality of nanogrid nodes. Each nanogrid node is configured to modify the operation of its MID and power management component based on information exchanged via the peer-to-peer wireless connection.

This application claims the benefit of:
U.S. provisional patent application No. 63/569,986, filed on Mar. 26, 2024;
U.S. provisional patent application No. 63/680,432, filed on Aug. 7, 2024;
U.S. provisional patent application No. 63/683,114, filed on Aug. 14, 2024; and
U.S. provisional patent application No. 63/689,550, filed on Aug. 30, 2024.

This application is also a continuation-in-part of U.S. patent application Ser. No. 19/083,668, filed on Mar. 19, 2025.

The disclosures of each of the above-referenced applications are incorporated by reference herein in their entireties.

### FIELD

The present disclosure relates to systems and techniques for power generation and energy storage at a premises, and more specifically, to systems and techniques for orchestrating distributed behind-the-meter nanogrids.

### BACKGROUND

Traditional centralized building-integrated energy storage systems face challenges related to high installation costs, modification inflexibility after initial setup, and limited granularity in managing individual loads. More specifically, traditional backup power systems and home energy management solutions provide limited or no control, insight, or optimization of connected appliances and electrical loads within a home or building. Solutions such as whole-home battery systems and centralized “behind-the-meter” (BTM) battery energy storage systems (BESS) face challenges of high installed costs, complex installation, lack of practical support for multi-tenant building styles and rental properties, and lack of granular intelligence at the level of individual building/home areas and appliances.

Current residential and commercial microgrid and distributed energy resource (DER) technologies are largely designed as fixed infrastructure, leading to high installation costs, complex permitting processes, and difficulty scaling up or modifying the systems as occupant needs and goals change over time. As fixed-in-place electrical infrastructure, these systems are designed with centralized microgrid control system (MCS) software and physically connect to a central point within the building's electrical distribution system (e.g. to a single load center and set of electrical feeder conductors). This design approach hinders the adaptability, scalability and efficacy of current battery backup and energy management solutions.

Remote orchestration of DERs at scale has been demonstrated within Virtual Power Plants (VPPs). These software-defined systems have been tailored exclusively to status quo fixed-in-place battery microgrids, and therefore, control granularity is limited to individual utility customers (i.e. at the whole-home or utility meter level).

### BRIEF DESCRIPTION OF THE DRAWINGS

FIG. 1 shows illustrative embodiments of nanogrid nodes.

FIG. 2 is a system level block diagram showing functional elements of an example of a nanogrid node and software-defined interactions at a premises aggregate level.

FIG. 3 is a system level block diagram showing an example of nanogrid nodes forming a nanogrid mesh, along with software interactions with on-premises and remote software systems.

FIG. 4 illustrates communication logic at an individual node, including an aggregation function to synthesize site-level power, energy, and status across nanogrid nodes.

FIG. 5 depicts a flowchart diagram of the nanogrid node core software functions.

FIG. 6 depicts a flowchart illustrating logical states to securely register and de-register new nanogrid nodes on the mesh network for scalability.

FIG. 7a illustrates a fully connected nanogrid mesh topology, in which each node is directly connected to every other nanogrid node.

FIG. 7b illustrates a nanogrid mesh topology in which an Extender Node has been added to the nanogrid system to extend the wireless coverage.

FIG. 7c illustrates a nanogrid mesh topology in which separate nanogrid nodes have connections to different devices outside the mesh network.

FIG. 8 is a flowchart of an example process for providing a unified representation of a nanogrid system including a plurality of nanogrid nodes.

### DESCRIPTION

The present disclosure addresses the need for operating advanced, adaptable, and cost-effective energy management and backup power solutions in residential and commercial settings. Traditional centralized building-integrated energy storage systems face challenges related to high installation costs, modification inflexibility after initial setup, and limited granularity in managing individual loads. To overcome these limitations, this disclosure introduces a nanogrid mesh system, which includes multiple behind-the-meter battery nanogrid nodes distributed throughout a building's electrical system, and a system and set of methods for orchestrating such nanogrid nodes using a sophisticated software mesh communication network to aggregate their capabilities and behaviors as a single system. These nanogrid nodes provide unprecedented scalability and intelligent energy management alongside essential loads without the need for extensive electrical retrofit labor. The nanogrid nodes are autonomous, self-adapting communication nodes capable of coordinating multiple nanogrids within a building to provide real-time power control, predictive maintenance, energy optimization and advanced analytics at the premises level. The nanogrid mesh system is capable of coordinating with onsite solar photovoltaic systems, electric vehicle charging stations, centralized battery storage, and building management systems, while also enabling direct communication with non-nanogrid-connected loads and utility meters. This system introduces a number of advanced capabilities due to its distributed architecture, including dynamic load balancing, adaptive power routing, distributed computation for energy optimization, and integrated renewable energy forecasting, all managed through a dynamic system-level rules engine to optimize energy distribution and cost savings. By providing real-time feedback through client applications and utilizing cloud-based or local software for enhanced functionality, the nanogrid mesh system represents a significant advancement in residential energy management, offering improved flexibility, cost-effectiveness, and user control.

The need for resilient, intelligent, and flexible home backup power and energy management solutions continues to grow with the increasing frequency of power outages, rising electricity costs, and dynamic utility tariffs presenting greater opportunities for energy optimization. Traditional backup power systems and home energy management solutions often fall short in providing granular control, insight, and optimization of connected appliances and electrical loads within a home or building. Solutions like whole-home battery systems and centralized “behind-the-meter” (BTM) battery energy storage systems (BESS) face challenges of high installed costs, complex installation, lack of practical support for multi-tenant building styles and rental properties, and lack of granular intelligence at the level of individual building/home areas and appliances.

Current residential and commercial microgrid and distributed energy resource (DER) technologies are largely designed as fixed infrastructure, leading to high installation costs, complex permitting processes, and difficulty scaling up or modifying the systems as occupant needs and goals change over time. As fixed-in-place electrical infrastructure, these systems are designed with centralized microgrid control system (MCS) software and physically connect to a central point within the building's electrical distribution system (e.g. to a single load center and set of electrical feeder conductors). This design approach hinders the adaptability, scalability and efficacy of current battery backup and energy management solutions.

Remote orchestration of DERs at scale has been demonstrated within Virtual Power Plants (VPPs). These software-defined systems have been tailored exclusively to status quo fixed-in-place battery microgrids, and therefore control granularity is limited to individual utility customers (i.e. at the whole-home or utility meter level). While this virtual orchestration provides value at the electric distribution grid level, we lack systems that address the need for on-premises (i.e., behind-the-meter) orchestration of dispersed battery nanogrid systems to meet the specific needs of buildings and their occupants.

Connected (e.g. Wi-Fi-enabled) devices have grown in popularity in recent years, as Internet of Things (IoT) solutions have gained prevalence. In some cases, these devices have even demonstrated the ability for remote orchestration to provide energy management through participating in Demand Response (DR) programs. However, these solutions rely on internet connectivity to operate, typically connected via the occupant's Wi-Fi network and limited by pre-installed functionality of the IoT device and limitations of the device manufacturers' hardware and software. This approach presents challenges in maintaining reliable connections over the long term, meeting real-time control requirements with low latency, and performing local optimization and decision making in the absence of an internet connection. Moreover, today's home IoT products typically remain unaware—at the device level—of the broader product and building ecosystem in which they exist, limiting their usefulness.

Mesh networking technology has gained mass popularity to provide reliable local area networks (LAN) in the form of mesh Wi-Fi systems. Meanwhile mesh communication technology has rapidly progressed across several other technologies such as Matter/Thread and Zigbee. However, application layers and methods for connecting and controlling battery nanogrid systems leveraging these technology advances do not yet exist.

The current state of residential and small-commercial microgrid and backup power solutions highlights the need for cost-effective, intelligent, and easily deployable solutions that provide power resilience and energy optimization. The next generation of microgrid and nanogrid product and software solutions must support simple installation, easy scale-up over time, intelligent premises-level energy awareness, seamless integration within the building's product ecosystem to effectively address the shortcomings of traditional solutions.

The present disclosure is directed toward enhancing the accessibility, robustness, and performance of distributed behind-the-meter energy storage systems for backup power, building-level power control, energy management, energy optimization, and data insights into the built environment. This is achieved by introducing a system for communication, software-defined control, and optimization between a collection of battery-based nanogrid nodes connected in a distributed manner throughout a building's electrical distribution system. This system addresses shortcomings of traditional centrally-managed, fixed-in-place, battery-based microgrid systems and/or IoT appliances by enabling a deployment and coordination of a distributed system of interconnected nanogrid nodes, that are simple to install and scale, and are each capable of autonomous operation and coordination through a shared software framework.

Use of this system fundamentally enables low-cost, plug-and-play nanogrid systems to deliver functionality of traditional central, fixed-in-place behind-the-meter (BTM) microgrid systems without complex centralized installation, while providing additional and previously unavailable granular level control and energy usage insights. By leveraging existing electrical connection interfaces in buildings (e.g. AC power receptacles and/or power within appliances), nanogrid nodes may be rapidly deployed and scaled without costly electrical retrofit.

The nanogrid mesh system described below signifies a departure from central-controlled approaches of operating traditional fixed and portable backup power systems and IoT appliances. It introduces methods to enable intelligent, interconnected power nodes distributed to convenient locations within a building or home. This system represents a novel decentralized energy management system with properties in redundancy and self-healing, scalability, electrical safety, and security.

In this disclosure, a distinction is drawn between a microgrid and a nanogrid. A “microgrid” is defined herein as a premises wiring system that includes power generation, energy storage and one or more loads, and includes the ability to disconnect (i.e., to intentionally “island”) from and to operate in parallel with the primary source. Microgrids contain some or all of the premises distribution system (e.g., load centers and feeder conductors) to provide broad coverage of the electrical system. As such, a microgrid necessarily contains fixed-in-place (i.e. non-temporary) electrical equipment subject to specific installation and permitting requirements. For a residential microgrid, the primary source is generally considered to be the electric utility grid.

In contrast, a “nanogrid” is defined herein as a self-contained system, designed for operation at a premises (e.g., a home or small business), that may be electrically connected in either a temporary or non-temporary manner and that includes energy storage, connection points for generation, and connection points for one or more loads, and includes the ability to disconnect from and operate in parallel with the premises wiring system (i.e., with the utility grid). A nanogrid has the ability to operate within a microgrid, Hence, one or more nanogrids can exist as nested elements within a premises' microgrid system, or may exist in the absence of a larger microgrid system such that all intentional islanding capabilities across the site are limited to each independent nanogrid.

### Electrical System and Nanogrid Nodes

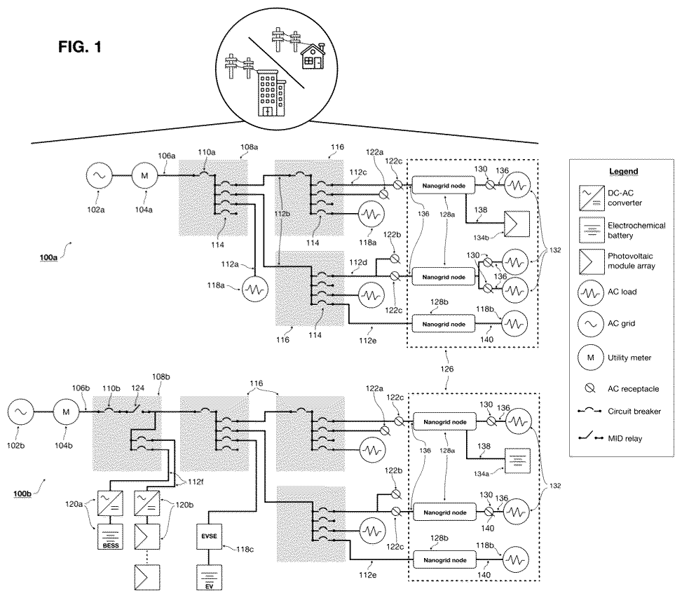

The physical (hardware) aspect of the nanogrid mesh system 126 is defined by nanogrid nodes 128a-b. A nanogrid node is designed to be electrically connected at any location within a premises alternating current (AC) wiring system 100a-b (i.e., behind the meter) exemplified in FIG. 1. FIG. 1 shows illustrative embodiments of nanogrid nodes, detailing power routing between grid, storage battery, connected AC and DC appliances and devices, and optional external solar and storage battery modules. In this context, premises may be considered to be a home, apartment unit, or physical building with an associated and integrated electrical distribution system for which one or more electric utility meters 104a-b is connected to a utility distribution grid 102a-b and is supplied electrical power via AC feeder service conductors 106a-b to a primary electric distribution panelboard or disconnecting means 108a-b (i.e. the Service Equipment) containing primary overcurrent protection device(s) (OCPDs, also known as circuit breakers) 110a-b which in turn feed branch circuits 112a-f via branch circuit breakers 114. Branch circuits may feed additional electrical panelboards 116, fixed-in-place loads 118a-c or sources (i.e. hard-wired, non-temporary loads) 120a-b, or one or more electrical receptacles 122a-c. In some embodiments, the AC distribution wiring system is designed in a split-phase configuration with three current carrying conductors (Line 1, Line 2, and Neutral) having Line-to-Neutral (L-N) voltage of nominally 110˜120 AC volts root-mean-squared (V RMS) and Line-to-Line (L-L) voltage of nominally 110˜120 AC volts root-mean-squared (V RMS). In other embodiments, the AC distribution wiring system is designed in a single-phase configuration with two current carrying conductors (Line 1 and Neutral) having Line-to-Neutral (L-N) voltage of nominally 110˜277 AC volts root-mean-squared (V RMS). In other embodiments, the AC distribution wiring system is designed in a three-phase wye configuration with four current carrying conductors (Line 1, Line 2, Line 3, and Neutral) having Line-to-Neutral (L-N) voltage of nominally 110˜277 AC volts root-mean-squared (V RMS) and Line-to-Line (L-L) voltage of nominally 208˜480 AC volts root-mean-squared (V RMS). In some embodiments, a premises-level microgrid is included in the premises distribution system, containing a means for islanding (i.e. via a Microgrid Interconnection Device, MID 124) and, in select embodiments, also containing onsite solar photovoltaic (PV) generation device(s) 120b and an onsite centralized battery energy storage system (BESS) 120a.

In some embodiments, electrical connection of a nanogrid node to premises AC wiring is achieved via a power cable 136 connected to an AC power receptacle 122c (e.g., NEMA 5-15R, 1-15R, or 5-20R in the North American market). In some embodiments, the nanogrid node's electrical connection to the premises wiring system is achieved by making a direct-wired connection via a set of branch conductors 112e connected to an OCPD (e.g. circuit breaker) with no intervening receptacle.

Similarly, in some embodiments, one or more loads 132 may be connected to a nanogrid node 128a via a detachable power cord 136 to one or more AC receptacles 130 contained on the nanogrid node. In select embodiments, one or more loads 118b may be connected to a nanogrid node 128b via a direct wired connection 140 to on the nanogrid node without an intervening AC receptacle (e.g., NEMA 5-15R, 1-15R, or 5-20R) via field-installed conductors.

In select embodiments, DC sources such as solar PV panel strings 134b and battery modules 134a may be connected to the nanogrid node to confer the system with additional energy storage and electrical generation capacity.

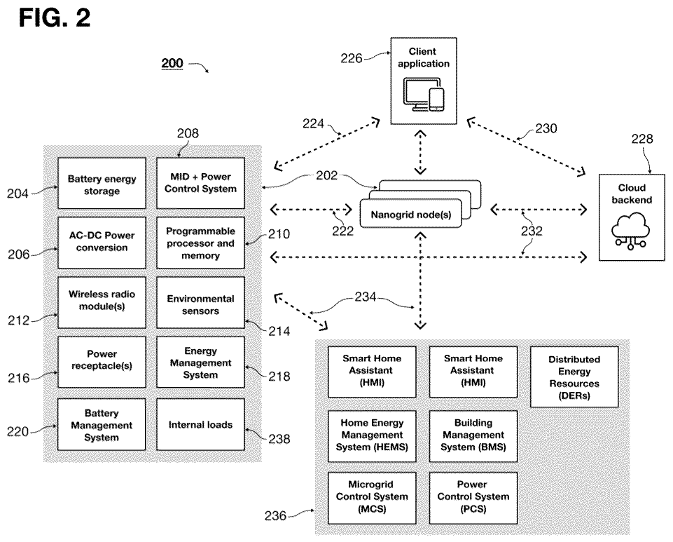

The physical form of a nanogrid node is a self-contained device possessing the necessary mechanical, electrical, and programmable components to manage software-controlled electrical disconnection (“intentional islanding”) from the premises electrical system, to supply voltage and manage power to a combination of directly-connected and/or integrated loads, energy storage, energy generation, as well as communication and interaction with a nanogrid mesh network and external software systems. In some embodiments, as illustrated in FIG. 2, a nanogrid node 202 contains a rechargeable battery energy storage module 204, AC and DC power conversion 206, a Microgrid Control System (MCS) and Microgrid Interconnection Device (MID) to enable intentional islanding behavior 208, a programmable processor and memory 210 running onboard software and firmware, wireless radio modules 212, environmental sensors 214, one or more AC and/or DC power receptacles 216, an Energy Management System 218 consisting of actuators for modulating power flow and sensors for measuring electrical voltages and current flows and programmable logic, and a Battery Management System 220 to prevent safety issues related to over-temperature, overcurrent, and over-voltage events within the Nanogrid system. One or more AC and DC loads may be connected to the nanogrid node. In some embodiments, the nanogrid node contains a combination of AC and DC loads internal to the device 238 such as motors, compressors, fans, electric resistance heaters, actuators, solenoid-controlled valves, lighting, and other electronic components. In some embodiments, the nanogrid node includes one or more user-accessible electrical connections for a DC solar photovoltaic (PV) panel or string of series-connected solar PV panels attached via wiring connectors. At least elements 204, 206, 208, 210, 218 and 220 in FIG. 2 are collectively a power management component configured to provide backup power to one or more loads within at least a portion of the nanogrid system.

Each nanogrid node is designed to be highly programmable, equipped with local data storage, memory, and real-time clock (RTC) 210 to buffer collected data and store instructions, such as to enable event-based battery dispatch. This allows Nodes to execute custom processing tasks, manage data locally, and respond dynamically to changing conditions measured by one or more nanogrid nodes, or operational commands.

The intentional islanding functionality conferred to each nanogrid node by the embedded MID, a device such as an electrical contact or relay that enables a microgrid (or nanogrid) system to separate from and reconnect to an interconnected primary power source, allows the nanogrid node to system to seamlessly switch between grid-tied and islanded modes (i.e. voltage-forming modes) without interruption, in a software-defined manner, ensuring continuous power supply during grid outages while maintaining synchronization with the main premises AC wiring system when available. The operation of the MID is controlled such as by the MCS, a structured control system that manages microgrid (or nanogrid) operations, functionalities for utility interoperability, islanded operations, and transitions.

Leveraging embedded Energy Management System software, nanogrid nodes with battery energy storage are designed to enable software-defined battery charge or discharge, monitoring, as well as enabling, disabling, or limiting power to connected load(s) for the purposes of energy management, power management, and protection of the connected loads in the event of power anomalies.

In select embodiments, nanogrid nodes and/or specialized connected sensors are designed with the ability to monitor power conditions at its interconnection point to premises AC wiring system (e.g., at the premises receptacle or branch conductor interconnecting the nanogrid node). This includes measurement voltage (e.g. line-to-line, line-to-neutral, neutral-to-ground), frequency, phase, power factor(s), current(s), and conductor temperature(s) to infer health metrics. In this way, a nanogrid node or connected sensor is designed to monitor conditions which affect its ability to safely exchange power with the broader premises electrical system such as impedance, N-PE continuity, overcurrent, and other metrics.

Taken together, the design of nanogrid nodes enables highly-localized local energy storage, energy management and energy optimization between connected loads, storage, and sources, as well as monitoring of connected/adjacent loads to provide users with insight into energy usage and environmental trends, and monitoring of power quality at its distributed connection point to the premises wiring.

### Nanogrid Mesh Network

When two or more nanogrid nodes are located on a premises wiring electrical system, the system is designed to form a nanogrid mesh network 200 featuring a decentralized architecture wherein nanogrid nodes 202 communicate directly with each other and relay operational and configuration data to other nanogrid nodes. This design is purpose-developed to eliminate the need for a central “broker” node, such as commonly used in IoT “hub-and-spoke” communication topologies, and thereby avoids a single point of failure, as each node functions as both a transmitter and receiver. In contrast, traditional communication systems used by today's DER systems employ a centralized model with a main hub or server managing device communication and orchestration.

In the formation of a nanogrid mesh network, each nanogrid node actively manages its connection to the shared wireless mesh network by continuously monitoring network conditions and adjusting its communication and data routing parameters to ensure stable and efficient data exchange with neighboring nanogrid nodes.

In select embodiments the nanogrid mesh network uses a combination of one or more wireless technologies for peer-to-peer communication, including LoRa, Wi-Fi, Thread, Bluetooth, Zigbee, and/or other wireless technologies 222. In some embodiments, the nanogrid mesh network (e.g., one or more of the nanogrid nodes) leverages TCP/IP to allow optional integration with other IP-based systems and to provide internet access to other devices. In some embodiments, the nanogrid mesh network uses proprietary communication protocols tailored to the specific application, which may not be based on TCP/IP.

In some embodiments, one or more nanogrid nodes maintains internet connectivity through one or more routes 232 such as Wi-Fi (e.g. via a Local Area Network), Ethernet, satellite internet (e.g., StarLink), and/or cellular network, ensuring consistent access to external resources and seamless integration with other IP-based systems. In particular, this internet connection facilitates communication with backend (i.e. Cloud) software systems 228 designed to interact with the Nanogrid Mesh Network. In some embodiments, a client software application on an external device (e.g. smartphone App or web-based application) 226 may directly communicate 224 with one or more nanogrid nodes (e.g. via Wi-Fi, Thread, Matter, or Bluetooth protocols), or communication to the client application may be routed via the Cloud system and internet connection 230, to facilitate system monitoring, managing settings, and/or issuing user-generated control commands.

In some embodiments, the Nanogrid Mesh Network, via one or more nanogrid nodes, supports programmable communication with other third-party software systems on premises (i.e. BTM) related to power, energy, data, and user interface 236 via APIs and conventional wireless or wired communication protocols (e.g. Wi-Fi, Zigbee, Matter, Thread, powerline communication, Bluetooth, Ethernet, CAN, RS485, and others) 234. Examples of such software integrations include Smart Home Assistants, other Distributed Energy Resources such as solar PV systems and battery energy storage systems, Home Energy Management Systems, Building Energy Management Systems, Microgrid Control Systems, and/or Power Control Systems. Data exchange and software-based interoperability with these third-party systems confers greater energy data context both to the nanogrid mesh system and to these third-party systems allowing for further optimized energy management and power control functionality benefitting building owners and occupants.

The nanogrid mesh network is specifically designed to include self-healing abilities; if a node fails or a communication link is broken, the network automatically reroutes data through other available paths, enhancing reliability and resilience. In other network configurations, such failures can lead to significant disruptions or require manual intervention for reconfiguration. Each node on the nanogrid mesh network performs periodic health checks to assess network performance and can automatically reconfigure to ensure efficient energy distribution and system resilience.

Scalability is a significant advantage of the nanogrid mesh network. Adding new nodes expands the network's coverage and energy capacity without significantly affecting existing performance, allowing nodes to join or leave without disrupting overall connectivity. The traditional communication networks used for today's DERs, however, often face scalability limitations and may require substantial reconfiguration, re-installation, or additional infrastructure as more DERs are added. The system is designed for simple, secure pairing and unpairing. In some embodiments, this is achieved via a client application and user interface connected to one or more nanogrid nodes on the network.

The nanogrid mesh network provides inherent redundancy and reliability through multiple data transmission pathways, ensuring continued operation even if some nodes or links are compromised. This significantly increases the network's overall reliability. Conversely, centralized or hierarchical network designs are more vulnerable to outages due to single points of failure.

Dynamic routing in the nanogrid mesh network allows nodes to determine the best path for data based on current network conditions, such as traffic load and node availability. This adaptive routing improves efficiency and performance, unlike other networks that typically have predefined, less flexible routing paths, leading to bottlenecks and inefficient data transmission.

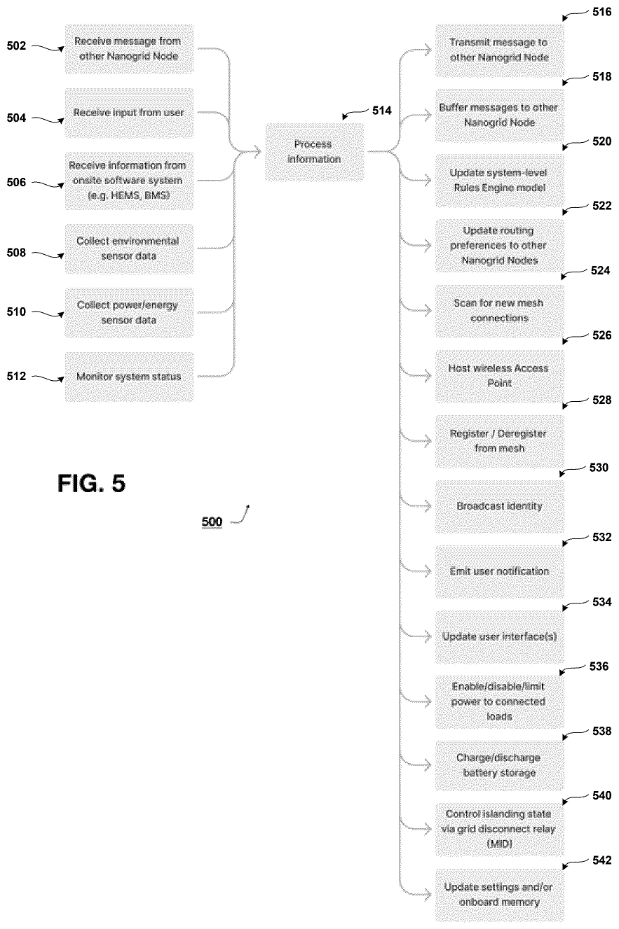

The nanogrid mesh network facilitates peer-to-peer communication 222, enabling nanogrid nodes to communicate directly without needing a central server or intermediary. This model allows for more direct and potentially faster communication. In contrast, traditional networks often rely on intermediary devices or servers, introducing delays and additional complexity. An example of a communication state machine 400 for a nanogrid node within the mesh network is shown in FIG. 4. When a nanogrid node initializes, it enters the Idle state 402, not actively processing or transmitting data, and waits for a predetermined time or event trigger. When this condition is met, the nanogrid node transitions to the Listening state 404, where it activates the receiver and listens for incoming data packets. If the nanogrid node receives data, it transitions to the Processing state 406, where it validates and parses the data, extracting relevant information such as power consumption and network status. If the data is valid, the nanogrid node transitions to the Aggregating state 408. In this state, the nanogrid aggregates the received data with its local parameters, updating local power consumption and generation metrics and calculating the sum or combination of data from itself and neighboring nodes. Once the aggregation is complete, the nanogrid node transitions to the Transmitting state 410, preparing the aggregated data for transmission. The nanogrid node formats the data into packets suitable for mesh network transmission and sends the data to neighboring nodes. After transmission, the nanogrid node transitions to the Updating state 412, where it updates its local parameters and network aggregated data, logging any significant events or errors. Upon completing the update, the nanogrid node returns to the Idle state 402, ready to start the process again. This state machine ensures that each node effectively manages communication, processes data, and maintains updated and accurate network-wide parameters. Such peer-to-peer communication and data aggregation functionality allows the system to maintain an accurate and up-to-date model of the entire system's state (e.g. aggregate energy capacity, power, islanding state, and electrical-spatial model of building energy), which is used to inform decision-making and changes to operation at the Nanogrid level and Nanogrid Mesh system level.

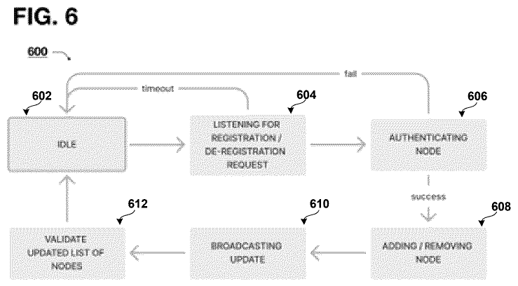

FIG. 5 depicts a flowchart diagram of an example of a nanogrid node's core software-implemented functions 500. A nanogrid node may include a programmable processor and memory 210 (FIG. 2) to implement software-implemented functions 500. In at least one embodiment, software-implemented functions 500 include the following input-processing functions:
1) receiving messages from one or more other nanogrid nodes 502;
2) receiving messages from one or more users (e.g., as settings updates provided via smartphone App, onboard user interface(s), API communication, etc.) 504;
3) receiving information from an on-site software system (e.g., HEMS, BMS, MCS, PCS) 506;
4) collecting environmental sensor data (e.g., from onboard sensors or wirelessly-paired sensors) 508;
5) collecting power/energy sensor data (e.g., from onboard sensors or external sensors paired to the nanogrid node) 510; and
6) monitoring system status (e.g., state of energy, operational and fault status, metrics related to mesh network performance, etc.) 512.

The nanogrid node processes any or all of the aforementioned information 514 (e.g., using programmable processor and memory 210) to produce any one or more of the following output-related functions:
1) transmitting one or more messages to one or more other nanogrid nodes 516 in the mesh (e.g., as updated aggregate power or energy data, power and energy data specific to this particular nanogrid node, system status related to this particular nanogrid node, metrics related to mesh communication performance, etc.);
2) buffering one or more messages to one or more other nanogrid nodes 518;
3) updating a system level rules engine model (e.g., relating to system settings, energy and power limits, 1^{st}- and 3^{rd}-party communication settings, grid code power and voltage limits, etc.) 520;
4) routing preferences to other nanogrid nodes 522;
5) scanning for new nanogrid mesh connections (e.g., using user-inputted unique ID codes, pre-configured and/or rotating security key(s), etc.) 524;
6) hosting wireless access for one or more other nanogrid nodes 526;
7) registering and/or deregistering the nanogrid node from the mesh 528;
8) broadcasting the nanogrid node's identity to other nanogrid nodes in the mesh 530;
9) outputting user notifications (e.g., to external smartphone apps, web dashboards, monitoring systems, etc.) 532;
10) updating onboard user interfaces (e.g., display screen(s), status LED(s), etc.) 534;
11) enabling, disabling and/or limiting power to connected loads (e.g., by actuating a power relay, actuating a control relay or MOSFET, modifying the onboard DCAC's output power characteristics, sending a software request to a connected appliance or device, etc.) 536;
12) charging and/or discharging battery storage 538;
13) controlling islanding state via the grid disconnect relay (MID) 540; and
14) updating settings and/or onboard memory 542.

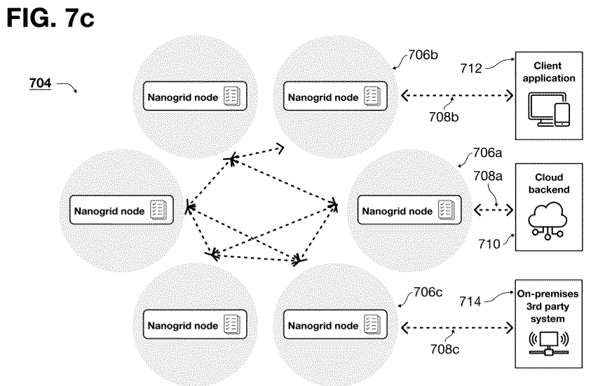

The mesh network can utilize various topologies to facilitate efficient communication and data management, which is illustrated in FIGS. 7a, 7b and 7c. In some embodiments, as shown in FIG. 7a, the system employs a fully connected nanogrid mesh topology 700, in which each nanogrid node is directly connected to every other nanogrid node, providing redundancy and reliability. This configuration allows for multiple communication paths, enhancing network resilience and fault tolerance. Alternatively, the system may use a partial mesh topology 702, where nodes are only connected to a subset of other nodes. This approach reduces the number of connections each node must manage, in some scenarios lowering the complexity and cost while still maintaining sufficient redundancy. In other embodiments, the network may adopt a hybrid topology that combines elements of both mesh and star configurations. In this setup, a nominated central node or set of nodes manages key communication and coordination tasks, while other nodes connect in a mesh pattern. This combination can optimize the balance between network robustness, scalability, and efficiency, ensuring that critical data paths remain robust while reducing overhead.

Importantly, connections to optional devices and software systems are not required to communicate to all nanogrid nodes on the mesh network. As an example 704, as shown in FIG. 7c, one nanogrid node 706a may maintain connection 708a to the cloud backend system 710 while a separate nanogrid node 706b maintains connection 708b to a client application (e.g. a smartphone application) 712, yet another nanogrid node 706c maintains connection 708c to on-premises devices and/or software systems (e.g. a third party DER, MID, EMS, HEMS, BMS, and/or monitoring systems) 714. In some embodiments, the nanogrid mesh system is capable of dynamically passing connection to optional devices and software systems between nanogrid nodes, by securely sharing connection details to these systems across the nanogrid mesh network, and in doing so allow for high connection strength and reliability to these systems.

The nanogrid mesh network is designed to provide extended coverage in areas where traditional networks struggle, as each node helps extend the network's range. This is particularly useful in large or irregularly shaped areas. Other networks typically limit coverage to the range of the central node or infrastructure, potentially leaving gaps in larger or more complex environments.

In some embodiments, as shown in FIG. 7b, one or more extender (nanogrid) nodes 716 may be added to a nanogrid system 702 to extend the wireless coverage in areas where the addition of nanogrid nodes is not required, addressing gaps in wireless coverage. Extender nodes will typically contain at least wireless radio(s), antennas, onboard processing, and one or more components for enabling the extender node to remain powered.

In some embodiments, a site-level controller (or central broker device) may be included for ease of interfacing with other devices and systems. However, in other embodiments, such a device is not required, as all nanogrid nodes are capable of maintaining site-level awareness and coordinating autonomously to provide high network performance and reliability.

### Nanogrid Mesh Network Security and Privacy

The nanogrid mesh system can be equipped with several advanced features to ensure heightened security and privacy for users and their data, including but not limited to Encryption, Intrusion Detection and Response, Dynamic Routing and Load Balancing, and Localized Security Zones.

The nanogrid mesh system employs local communication, allowing nodes to interact directly without the need for a central hub. This reduces the number of points where data can be intercepted, significantly enhancing privacy. Additionally, the system uses peer-to-peer encryption for direct node-to-node communication, such that data in transit is protected, ensuring that only intended recipients can read the messages, thus safeguarding sensitive information from unauthorized access.

Each node in the nanogrid mesh system is capable of distributed monitoring, where traffic is continuously observed for unusual patterns or anomalies. This proactive approach helps in identifying and responding to threats swiftly. Moreover, the system supports collaborative defense, where nodes can work together to isolate compromised nodes, thereby reducing the spread of attacks and maintaining the integrity of the network.

The nanogrid mesh system features adaptive path selection, allowing it to dynamically choose the best paths for data based on current network conditions, including security considerations. This adaptability makes it more difficult for attackers to predict and target specific paths. Furthermore, by evenly distributing traffic, the system can prevent overload on any single node, mitigating the risk of Denial of Service (DOS) attacks and ensuring continuous, reliable operation.

The system's design allows for the easy addition of security-enhanced nodes, facilitating incremental improvements in security without necessitating a complete overhaul of the network. Security policies can also be updated and propagated dynamically across the network, so that all nodes have the most up to date protections. This flexibility supports both immediate and long-term security needs as the network grows.

The nanogrid mesh system can create localized security zones, where sensitive data is only accessible to certain nodes. This segmentation reduces the risk of broad data exposure. Additionally, the system implements granular access control at the node level, allowing for fine-grained permissions and better protection of sensitive resources. This ensures that only authorized devices and users can access critical parts of the network, further enhancing security.

To ensure the nanogrid mesh system can leverage state-of-the-art security practices and functionality, each nanogrid node's programmable processor and memory unit 210 is designed to support over-the-air (OTA) software updates, which may be transferred to one or more individual nanogrid node via the Internet (e.g. via Wi-Fi or Ethernet), via connection to a smartphone app (e.g. via shared Wi-Fi, Bluetooth, and/or Thread connection), and/or via direct interface with the Nanogrid device (e.g. via a USB serial connection).

In summary, the nanogrid mesh system's advanced security and privacy features—including enhanced data privacy, intrusion detection and response, dynamic routing and load balancing, scalability and flexibility, and localized security zones-work together to provide a robust and secure energy management solution.

### Dynamically Adding and Removing Nanogrid Nodes on the Network

An aspect of the nanogrid mesh network is the ability to expand over time by adding or removing nodes. To support this capability, the system can be configured for simple, secure pairing and unpairing.

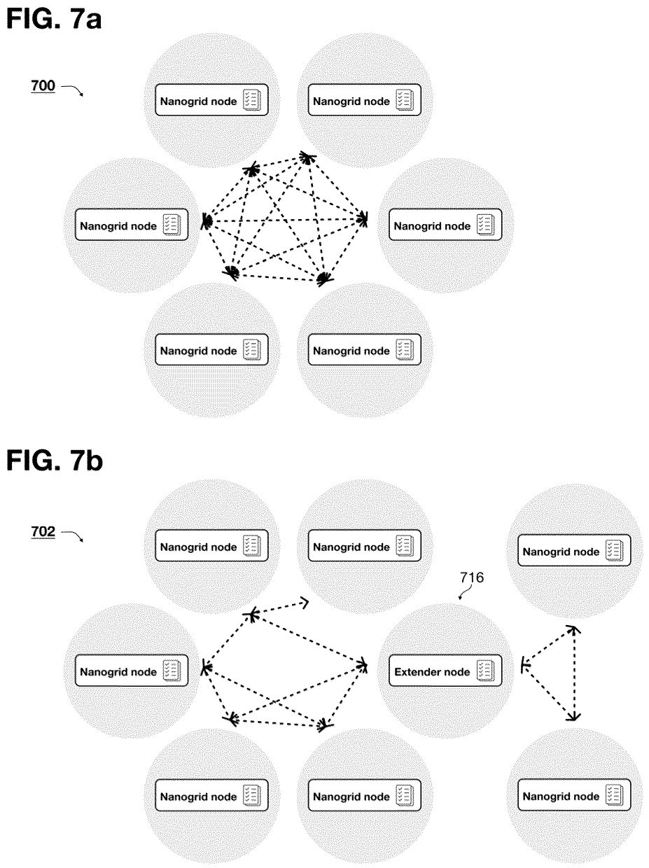

The process of registering and de-registering nodes in the mesh network (that is, adding and removing nanogrid nodes) can be designed with several distinct states and transitions 600, such as illustrated in FIG. 6. Initially, a node remains in the Idle state 602, not engaged in any specific registration or de-registration activity. In some embodiments, a registration/de-registration event may be triggered via a software command (e.g. API call). In other embodiments, a physical interaction such as button-press on device or a measurement at a sensor is used to initiate and validate the request. In other embodiments, registration may occur automatically once a new nanogrid node is powered on within the network range of existing nanogrid node(s), facilitated by pre-shared security key(s) designed for secure authentication. When a new nanogrid node connects to the nanogrid mesh network and sends a registration request, the receiving nanogrid node transitions to a state of Listening for Registration Requests 604. Upon receiving a request, the nanogrid node moves to the Authenticating Node state 606, where it verifies the credentials of the requesting node. In some embodiments, authentication leverages a connection to a secure backend server to check for a valid UID, while in other embodiments the system uses secure means for local validation. If authentication is successful, the node proceeds to the Adding Node state 608, where it registers the new node and updates the network topology accordingly. Following this, the node transitions to Broadcasting Update (Addition) state 610, during which it disseminates the updated list of registered nodes to the entire network, and validates receipt of this update in Validation state 612. The node then returns to the Idle state 602.

Similarly, when a nanogrid node sends a de-registration request, the receiving nanogrid node again transitions from the Idle state to Listening for De-registration Requests. After receiving a de-registration request, the nanogrid node moves to the Authenticating Node state to verify the credentials of the de-registering nanogrid node. Authentication may similarly involve checking with a secure backend server or using local validation methods. Upon successful authentication, the node enters the Removing Node state, where it de-registers the node and updates the network topology. Subsequently, the nanogrid node transitions to Broadcasting Update (De-registration), broadcasting the updated list of registered nodes to the entire network. Finally, the nanogrid node returns to the Idle state, ready to handle future requests.

### System-Level Aggregate Behaviors and Value

At a system level (i.e. with two or more nanogrid nodes forming a nanogrid mesh network) significant control and monitoring value arises, including electrification enablement (i.e., connection of new electric loads and/or sources to a home or building) via real-time power management at the premises level, as well as efficient energy management at the premises level (i.e. delivering Energy Management System, EMS, functionality).

To produce a system-level model of aggregate power, energy and system status, the nanogrid mesh system is designed to aggregate information from each nanogrid node into a premises-level virtual nanogrid system 302 representation by facilitating both real-time and periodic data exchanges between nodes. This continuous flow of information allows the system to dynamically update and optimize the overall energy management, storage, and distribution across the entire premises. Aggregated system information is propagated to each nanogrid node, allowing them to maintain an updated record of the premises-level virtual system and their own local system status and configuration. This ensures that each node operates with a comprehensive awareness of the overall network, enhancing coordination and optimizing energy management across the entire premises.

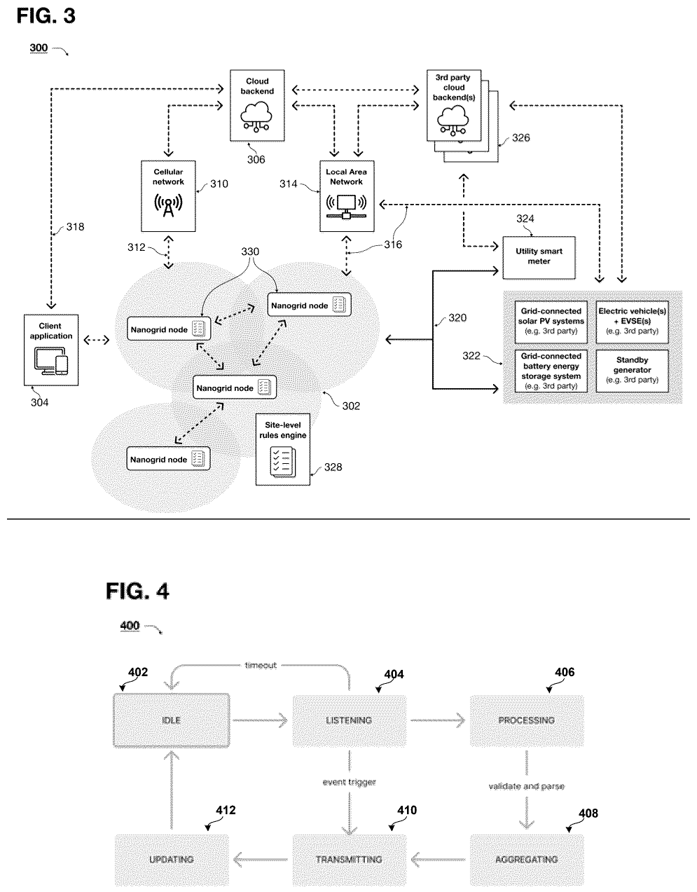

To achieve this, each nanogrid node maintains a dynamic description of its own operating data in a common structured data format, which includes details such as energy storage capacity, charge/discharge power, local AC voltage characteristics, and local system status. This standardized data structure ensures compatibility and seamless integration with a site-level rules engine, such as site-level rules engine 328 in FIG. 3. FIG. 3 shows an example of a system 300 of nanogrid nodes 330 forming a nanogrid mesh, including wireless coverage, along with software interactions with on-premises and remote software systems. The node's operating data is periodically updated and shared/advertised across the nanogrid mesh network, allowing for incorporating of this data into a system-level decision making processes, i.e., the site-level rules engine 328. By leveraging this consistent data format, the rules engine can effectively manage and optimize the entire system, ensuring efficient energy distribution and adherence to site-specific parameters and utility tariff requirements.

In some embodiments, nanogrid nodes advertise operational parameters such as real-time representations of available energy storage capacity (Wh) and charge/discharge power (W), both for the battery module and for the combined nanogrid node (i.e. including energy storage, load draw, and, where applicable, solar PV generation), status and power demand of connected loads, AC voltage(s) and frequency, current, power factor, phase information.

An aspect of the nanogrid mesh network is its rules engine mechanism that propagates model data to implement intelligent energy management strategies across the system. The rules engine contains both pre-set and dynamic information. In some embodiments, this includes site-level metadata, utility tariff data, setpoints related to power flow and power quality at specific locations in the premises wiring system, and limits for power exchange with the premises wiring system and the utility grid. By continuously processing real-time and periodic data from each nanogrid node, the rules engine dynamically adjusts operations to optimize energy distribution, enhance power quality, and increase cost savings based on current utility tariffs. This approach ensures that the system operates efficiently and adapts to changing conditions, maintaining high performance and reliability across the entire premises.

The system is designed to employ approaches to division of computational labor. In some embodiments, this is done by performing certain intensive optimizations in the Cloud, with results periodically sent to the local nanogrid network to update onboard software model parameters (e.g., via an Internet connection 312, 316 maintained by one or more nanogrid nodes 330, via Wi-Fi (e.g., a local area network 314), cellular network 310, or other route). In some embodiments, the system is designed to distribute computational tasks across nanogrid nodes, allowing each node to share in the processing load for computationally intensive optimization and prediction algorithms, ensuring efficient use of local resources and enhanced overall performance.

By leveraging the site-level rules engine and system model within the nanogrid mesh network, the system enables a number of aggregate functions, described below.

In some embodiments, the system is configured to manage net power flow between the premises and the utility grid (i.e. delivering Power Control System (PCS) functionality) by controlling power flow within each nanogrid node (i.e. between connected loads, storage, and generation) and between each nanogrid node and premises wiring system in concert, to produce a net change in current import/export across the electric utility meter on one or more pre-defined Line and/or Neutral conductors. In doing so, the nanogrid mesh is able to manage power and current limits inherent to feeder conductors, and/or to manage energy usage at the premises level to improve overall operational cost and carbon-intensity of the premises' electrical demand.

In some embodiments, the system in aggregate may be configured to perform Dynamic Load Balancing, implementing an intelligent load-balancing mechanism that dynamically shifts energy consumption between various nanogrids based on real-time usage patterns, grid demand, and battery state of charge to optimize efficiency and reduce peak loads.

In some embodiments, the system is designed to provide premises-level monitoring of electrical system health (e.g., using voltage, frequency, power factor, impedance, conductor temperature and other parameters), equipment health, environmental conditions, and overall performance, offering a holistic view of the building's energy and ecosystem to support enhancing operational efficiency, reliability, and safety.

In some embodiments, the system in aggregate may be configured to perform adaptive power routing, commanding software-controlled power and energy setpoints between different nanogrid nodes based on factors such as utility time-of-use (TOU) tariff rates, utility demand charge tariffs, renewable energy availability, and user preferences to reduce energy costs and carbon footprint. Power routing and switching mechanisms are achieved by adjusting the charge/discharge power of the nanogrid node(s) battery module(s), managing power to nanogrid-connected loads, and managing power injection from nanogrid-connected sources. In some embodiments, power to connected loads is controlled by onboard power relays. In some embodiments, direct communication with loads and appliances is used to modulate power consumption.

In some embodiments, the system in aggregate may be configured to perform predictive maintenance and optimization by incorporating machine learning algorithms to predict maintenance needs and optimize the performance of the battery nanogrid system, analyzing historical data and environmental conditions to reduce downtime and extend component lifespan. This includes developing a model of building wiring system health based on data from each nanogrid node, such as impedance under various conditions, voltage, frequency, harmonics, power factor, and conductor temperature.

In some embodiments, the system in aggregate may be configured to perform advanced energy storage management by implementing a multi-tiered energy storage management system that prioritizes energy storage and discharge across various nanogrid nodes based on critical load requirements, user preferences, and predictive energy availability from renewable sources.

In some embodiments, the system in aggregate may be configured to perform real-time energy analytics and user feedback by providing real-time energy usage analytics and feedback through a mobile application or web interface, helping users understand their detailed energy consumption patterns, identify inefficiencies of specific appliances and loads, and make informed decisions to improve energy savings.

In some embodiments, the system in aggregate may be configured to perform Automated Demand Response (DR) by creating an automated system that adjusts energy consumption in response to grid signals, utility pricing, or environmental conditions, helping to balance grid load and reduce energy costs for users.

In some embodiments, the system in aggregate may be configured to perform integrated renewable energy forecasting by incorporating forecasting tools into the nanogrid management system to predict solar and wind energy generation, thereby allowing for improved planning and optimization of energy storage and usage.

In some embodiments, the system in aggregate may include maintenance and diagnostic tools by providing advanced tools and methods for predictive maintenance, diagnostics, and performance monitoring of the battery nanogrid system, including innovative approaches to fault detection and system health assessment.

In some embodiments, the system in aggregate may be configured to perform environmental monitoring and response by implementing methods to monitor environmental conditions, such as temperature and humidity, that affect occupant comfort and battery performance, then adjusting system operations accordingly.

Interactions with Other On-Premises and Remote Software Systems

The aggregated nanogrid mesh network system is designed with interoperability in mind, enabling seamless integration with various on-premises software systems 236; 322. This includes interfacing with solar photovoltaic (PV) systems, electric vehicle charging systems (EVSEs), larger centralized battery energy storage systems (BESS), and building management systems (BMS) or home energy management systems (HEMS), allowing for coordinated and optimized energy management across all components of the building's energy ecosystem.

In some embodiments, the system is configured to connect with 1st party and 3rd party client software applications 304, such as smartphone apps or web dashboards, providing users with intuitive access to real-time data, control features, and system insights, ensuring a comprehensive and user-friendly experience for managing their energy resources.

The system is also designed for integration with cloud backend systems (e.g., first-party or third-party DERMS and VPP orchestration systems) 306, 326, onsite software systems (such as third-party BMS, HEMS, and MCS), and for direct communication with non-nanogrid-connected end loads (e.g., central HVAC systems), and smart utility meters 324 via wireless protocols, facilitating comprehensive and flexible energy management across multiple platforms and devices.

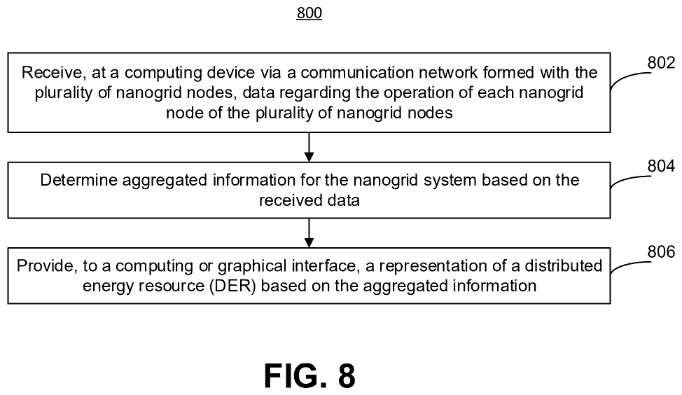

The system can be configured to connect 320 directly with distributed energy resources (DERs) 322 such as onsite solar photovoltaic (PV) systems, enabling efficient energy management and integration. Specifically, the aggregate system supports charging from onsite AC-coupled solar, allowing for optimized energy use by leveraging renewable energy generation to charge the nanogrid's battery storage. This capability ensures that the energy storage system benefits from solar energy, reducing reliance on grid power and enhancing overall sustainability. FIG. 8 shows an example process 800 for providing a unified representation of a nanogrid system including a plurality of nanogrid nodes. In some implementations, one or more process blocks of FIG. 8 may be performed by a device, such as a nanogrid node. As shown in FIG. 8, process 800 may include receiving, at a computing device via a communication network formed with the plurality of nanogrid nodes, data regarding the operation of each nanogrid node of the plurality of nanogrid nodes (block 802). For example, the device may receive, at a computing device via a communication network formed with the plurality of nanogrid nodes, data regarding the operation of each nanogrid node of the plurality of nanogrid nodes, as described above. As also shown in FIG. 8, process 800 may include determining aggregated information for the nanogrid system based on the received data (block 804). For example, the device may determine aggregated information for the nanogrid system based on the received data, as described above. As further shown in FIG. 8, process 800 may include providing, to a computing or graphical interface, a representation of a distributed energy resource (DER) based on the aggregated information (block 806). For example, the device may provide, to a computing or graphical interface, a representation of a distributed energy resource (DER) based on the aggregated information, as described above.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

What is claimed is:

1. A first nanogrid node configured to operate as one of a plurality of peer nanogrid nodes in a nanogrid system within a premises, the first nanogrid node comprising:
a power supply input to receive power from a power source that is external to the first nanogrid node and within the premises;
a switch coupled to connect or disconnect the first nanogrid node from the power source;
a rechargeable battery;
a power output to provide power to a load within the premises;
a communication interface configured to implement a peer-to-peer wireless connection with at least a second nanogrid node of the plurality of peer nanogrid nodes within the premises; and
a processing unit, including at least one programmable processor and memory, configured to control the nanogrid node to manage power flow within the premises cooperatively with the second nanogrid node, including to control operation of the switch to cause power to be provided to the power output selectively from the power supply input or from the battery.

2. The first nanogrid node of claim 1, wherein the peer-to-peer wireless connection comprises a wireless mesh network connection.

3. The first nanogrid node of claim 1, wherein the first nanogrid node further communicates with a third nanogrid node, of the plurality of nanogrid nodes, via the communication interface, such that the first nanogrid node, the second nanogrid node and the third nanogrid node form at least a portion of a wireless mesh network of nanogrid nodes.

4. The first nanogrid node of claim 1, wherein the processing unit is configured to manage the peer-to-peer wireless connection by continuously monitoring network conditions and adjusting one or more communication parameters based on the network conditions to achieve a specified quality of data exchange with the second nanogrid node.

5. The first nanogrid node of claim 1, wherein the processing unit is configured to control the peer-to-peer wireless connection to cause one or more power management commands for real-time management of power flow within the premises to be communicated between the first nanogrid node and the second nanogrid node.

6. The first nanogrid node of claim 5, wherein the one or more power management commands include:
first a command to charge or discharge a battery within one of the plurality of nanogrid nodes;
a second command to curtail use of solar power within the premises; and
a third command to manage power to a connected load within the premises.

7. The first nanogrid node of claim 1, wherein the processing unit is configured to repeatedly receive and apply new software via an over-the-air (OTA) software update process.

8. The first nanogrid node of claim 1, wherein the processing unit is configured to repeatedly update a data model of a power system of the premises.

9. The first nanogrid node of claim 8, wherein the processing unit is configured to control the peer-to-peer wireless connection to cause the data model of the power system of the premises to be shared between the first nanogrid node and the second nanogrid node.

10. The first nanogrid node of claim 1, wherein the processing unit is configured to cause the first nanogrid node to control power flow within the premises to provide power from the first nanogrid node to a load within the premises in response to a detected failure of the second nanogrid node.

11. The first nanogrid node of claim 1, wherein the processing unit is configured to control the first nanogrid node to provide a single point of communication, for the plurality of nanogrid nodes, to a third-party energy system, via an Internet Protocol (IP) network.

12. The first nanogrid node of claim 1, wherein the processing unit is configured to monitor power, energy and/or data collection at an aggregate level for the premises.

13. The first nanogrid node of claim 1, wherein the peer-to-peer wireless connection comprises a wireless mesh network connection, and wherein the first nanogrid node further communicates with a third nanogrid node, of the plurality of nanogrid nodes, in a mesh wireless mesh network.

14. The first nanogrid node of claim 1, wherein the first nanogrid node is configured to monitor statuses of each of a plurality of other peer nanogrid nodes in the nanogrid system and to dynamically adjust message routing based on the monitored statuses.

15. The first nanogrid node of claim 1, wherein the first nanogrid node is configured to:
monitor statuses of each of a plurality of other peer nanogrid nodes in the nanogrid system;
determine collective information for the nanogrid system based on the monitored statuses; and
generate and dynamically update a graphical user interface including display data indicative of a representation of a distributed energy resource (DER), based on the collective information.

16. The first nanogrid node of claim 1, wherein the first nanogrid node is configured to be dynamically added to and/or removed from the nanogrid system.

17. A nanogrid system for managing power within a premises, the nanogrid system comprising:
a plurality of nanogrid nodes configured in a nanogrid system, wherein each nanogrid node includes:
a connection to a power source within the premises;
a microgrid interconnection device (MID) configured to selectively disconnect from the power source;
at least one power management component configured to provide backup power to one or more loads within a portion of the nanogrid system; and
a peer-to-peer wireless connection with at least another nanogrid node of the plurality of nanogrid nodes, wherein the nanogrid node is configured to modify the operation of the MID and the power management component based on information exchanged via the peer-to-peer wireless connection.

18. The nanogrid system of claim 17, further comprising a nanogrid control system implemented on one or more of the nanogrid nodes of the plurality of nanogrid nodes and configured to monitor power, energy and/or data collection at an aggregate level for the premises.

19. The nanogrid system of claim 18, wherein the nanogrid control system is implemented in two or more separate computing devices.

20. The nanogrid system of claim 17, wherein the peer-to-peer wireless connection comprises a wireless mesh network connection.

21. The nanogrid system of claim 17, wherein a first nanogrid node of the plurality of nanogrid nodes is connected to an internet protocol (IP) network, and wherein a second nanogrid node of the plurality of nanogrid nodes is configured to connect to the IP network when the first nanogrid node loses the connection to the IP network.

22. The nanogrid system of claim 17, wherein each nanogrid node of the plurality of nanogrid nodes is configured to monitor status of its peer-to-peer connection(s) and to dynamically adjust message routing based on the monitoring.

23. The nanogrid system of claim 17, wherein each nanogrid node of the plurality of nanogrid nodes is configured to be dynamically added to and/or removed from the nanogrid system or a portion thereof.

24. A computer readable medium having instructions thereon, execution of which within a nanogrid system causes the nanogrid system to perform operations comprising:
communicating with each of a plurality of nanogrid nodes in the nanogrid system within a premises, wherein at least some of the communication is through multiple nanogrid nodes communicating other each other peer-to-peer; and
performing nanogrid system level analysis and/or updates based on the communicating.

25. The computer readable medium of claim 24, wherein analysis and/or updates comprise one of optimizing building-level energy and power, determining aggregate available energy storage capacity, determining net energy accumulation, providing instant charge/discharge power to a premises wiring system, determining available net power to be imported from the premises wiring system to nanogrid nodes, determining available net power to be exported to the premises wiring system from nanogrid systems, determining a status of connected loads, or determining system status and availability.

26. The computer readable medium of claim 24, wherein the analysis and/or updates comprise maintaining up-to-date aggregated views of multiple nanogrids within a common premises, wherein each of the nanogrids of the multiple nanogrids comprises a unique subset of the plurality of nanogrid nodes.

27. The computer readable medium of claim 24, wherein the analysis and/or updates comprise a model to identify electrical anomalies, thermal anomalies, or safety risks across a premises electrical distribution system.

28. The computer readable medium of claim 24, wherein the analysis and/or updates comprise reconciling requests and setpoints across the plurality of nanogrid nodes.

29. The computer readable medium of claim 28, wherein the reconciling requests and setpoints comprises prioritization based on user inputs or physical constraints of the electrical distribution system.

30. The computer readable medium of claim 29, wherein the physical constraints of the electrical distribution system comprise current ratings of conductors.

31. A method for providing a unified representation of a nanogrid system including a plurality of nanogrid nodes, the method comprising:
receiving, at a computing device via a communication network formed with the plurality of nanogrid nodes, data regarding the operation of each nanogrid node of the plurality of nanogrid nodes; and
determining aggregated information for the nanogrid system based on the received data;
providing, to a computing or graphical interface, a representation of a distributed energy resource (“DER”) based on the aggregated information.

32. The method of claim 30, further comprising at least one of:
managing energy within a premises electrical wiring system based on the DER; or
performing power control within a premises electrical wiring system based on the DER.
